(19) United States
(12) Patent Application Publication
(10) Pub. No.: US 2019/0254900 A1
(43) Pub. Date: Aug. 22, 2019

(54) MEDICAL MOBILITY DEVICE

(71) Applicant: Michel Pelletier, Ludlow, MA (US)

(72) Inventor: Michel Pelletier, Ludlow, MA (US)

(21) Appl. No.: 15/898,667

(22) Filed: Feb. 19, 2018

(51) Int. Cl. A61G 7/10; A61G 7/053

(52) U.S. Cl. CPC A61G 7/103; A61G 7/1038; A61G 2200/34; A61G 7/053

(57) ABSTRACT

A medical mobility device for use by a person comprising of a transfer board to shift between a first seated area to a second seated area and a handheld support which includes a gripping portion dimensioned for a person's hand and a paddle portion attached to the gripping portion in a substantially perpendicular relationship with respect to the paddle portion. A pair of handheld supports can be used simultaneously by a person holding one in each hand while transferring body weight across a transfer board.

### FIELD OF INVENTION

This invention relates generally to the field of medical mobility devices and is particularly directed to a medical mobility device for use with a wheelchair. More specifically, the present invention comprises a transfer board and a handheld support that allows users to shift themselves between a wheelchair and another sitting area.

### BACKGROUND OF THE INVENTION

People with limited mobility require additional assistance. Daily tasks can be a challenge depending on the range of motion each person has. In some cases, the person still retains the use of their upper body. Therefore, they are able to retain some limited motion. Various devices have been created to assist a disabled user regain some independent movement. As technology in the medical field progresses, better solutions are available for patients who do not have full use of their motor skills. Biomechanics and robotics are two fields focused on allowing patients with limited capabilities regain at least a portion of their independence. Some of these devices are complex and require consistent maintenance. In addition, they can be prohibitively expensive, making it unavailable to many in need.

The demand of care-giving work has also substantially according to the advance of aging in recent years. A care giver's daily physical loads are large, and also include frequent movement from a bed to a wheelchair and vice versa for elderly people and disabled persons. The burden this poses on a care worker's lumbar part is serious.

As a transferring device for easing a care worker's burden, there is a transfer board, a lifter until now.

Transfer boards, also called sliding boards, are an assistive device to help individuals move from one location to another, and to prevent slips and falls. They also aid caregivers in moving others with limited mobility, while reducing their own risk of leg or back injury.

Transfer boards are commonly used as a way for a user to transfer his or her body between a wheelchair and another sitting area, but they are often awkward for a person because there is no place to effectively grab onto something to shift his or her body weight across the board, and often people rely on other people to help them use the transfer board.

Mechanical assisting devices like a lifter, fixed to a wall, a ceiling or a bed or the like, are also commonly used. However it is not easy to transport, an installation place is limited and it is difficult to use it for daily care since it is large-sized and heavy even in the case of a moving type.

The present invention is developed in view of the above-mentioned point, and the handling, i.e. making a care receiver change a wheelchair bound person to a bed empty vehicle chair etc., or changing him to a bed from a wheelchair etc. is very simple and convenient.

### DISCLOSURE OF PRIOR ART

U.S. Pat. No. 6,036,216 describes a wheelchair with a detachable combined armrest and transfer board. The transfer board is attached to the wheelchair by a unique coupling. The transfer board is linked to the seating surface of the wheelchair and is reconfigurable from a first position in which the transfer board extends along one side of the seating surface to a second position in which the transfer board is capable of extending from the seating surface of the wheelchair to a second seating surface remote of the wheelchair. The coupling permits unrestricted movement of the transfer board relative to the wheelchair while maintaining a linkage between the wheelchair and the transfer board, thus aiding in stability of the transfer board. However this prior art patent does not claim the flat bottom handheld supports of the present invention

U.S. Pat. No. 7,954,180 claims a toilet transfer system for assisting a person to transfer between a wheelchair and a toilet. The system comprises a base unit that is attached to a toilet and that may be supported by one or more legs. The system further comprises a transfer board that is rotatably coupled to the base unit, allowing the transfer board to be positioned in a variety of positions without need to detach the toilet transfer system from the toilet. The transfer board may be pointed forward to allow the wheelchair to be positioned for transfer, pointed towards the wheelchair for transfer, and pointed back for compact storage between transfers and for normal use of the toilet. A coupling system accommodates height differentials between the toilet and the wheelchair, and allows the transfer board to become lifted up off the base unit and/or rotated without becoming misaligned from the base unit. However this prior art patent does not integrate the flat bottom handheld supports of the present invention.

U.S. Pat. No. 5,152,016 describes a transfer board comprising a flat board member having tapered opposite ends is provided to enable a patient to transfer from a chair to a bed or the like. The board has a plurality of rollers rotatably mounted thereon which support the buttocks of the patient to enable the patient to easily from one end of the board to the other. The board is also provided with a plurality of openings formed in the upper surface of the board into which a handle may be inserted to enable the patient to pull herself from one end of the board to the other. However this prior art patent does not claim the flat bottom handheld supports of the present invention.

### OBJECTIVES OF THE INVENTION

The general purpose of the present invention is to provide a transfer board, and a handheld support that allows users to shift themselves from a wheelchair to another sitting area.

One significant objective of the present invention is to provide a medical mobility device capable of relieving labors of a care receiver and a care giver in the transfer

Another objective of the present invention is to provide a medical mobility device capable of being safely and easily operated

Another objective of the present invention is to provide a medical mobility device capable of being used in a small space.

Yet another significant objective of the present invention is to provide a medical mobility device having a very simple constitution and being convenient in storage and carrying.

Yet another significant objective of the present invention is to provide a medical mobility device without any need of a driving source such as a motor.

Yet another objective of the present invention is to provide a medical mobility device that may be used to easily transfer a person in a seated posture between a wheelchair placed outside a toilet or a bathroom and a toilet bowl or a bathtub.

Yet another significant objective of the present invention is to provide a medical mobility device which reduces the burden on a caregiver.

These and other objects and features of the present invention will be apparent from the following detailed description, taken with reference to the figures of the accompanying drawing.

### SUMMARY OF THE INVENTION

The present invention provides a transfer board and at least one handheld support for use with the transfer board. A person can grab the handheld support and place some of their body weight over or near the handheld support and grab the handheld support, pressing it down onto the board, while maintaining a firm grasp on the handheld support. Likewise, the handheld support can be placed against the board and grabbed by the user to push his or her body weight away from their seated position to transfer their body across the board.

### BRIEF DESCRIPTION OF THE DRAWINGS

FIG. 1 is a perspective view of the present invention, which shows the handheld supports.

FIG. 2 is a perspective view of the present invention, which shows the transfer board.

FIG. 3 is a perspective view of a transfer board and handheld support, with a user seated on a bed near a wheelchair.

FIG. 4 is a perspective view of the user seated on the transfer board between the bed and the wheelchair while grasping the handheld support.

### DETAILED DESCRIPTION OF THE INVENTION

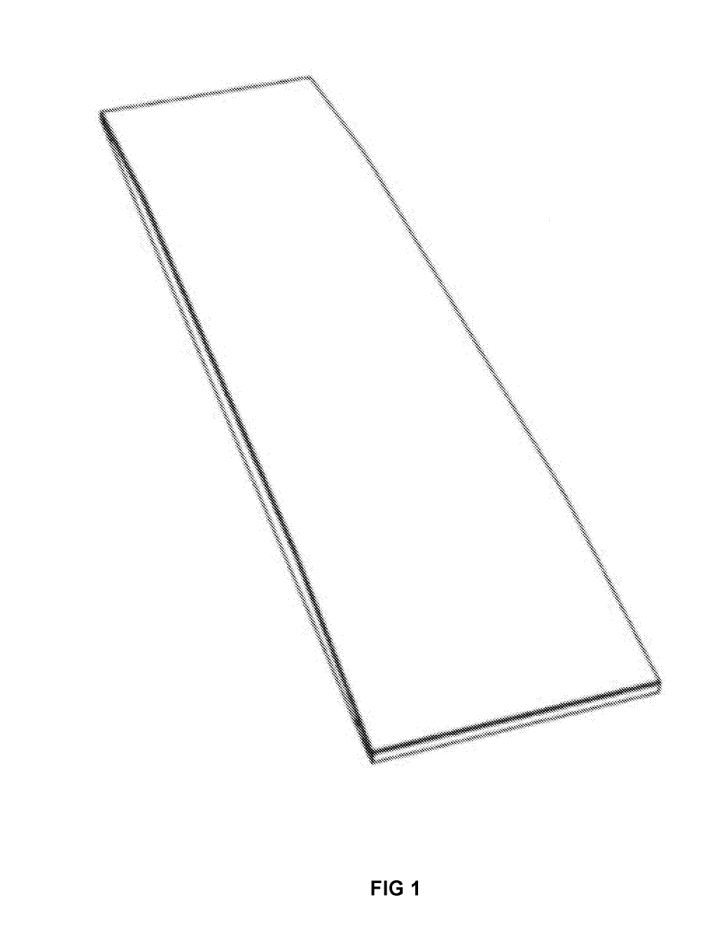

In that form of the present invention chosen for purposes of illustration, FIG. 1 shows the handheld support for use along with the transfer board

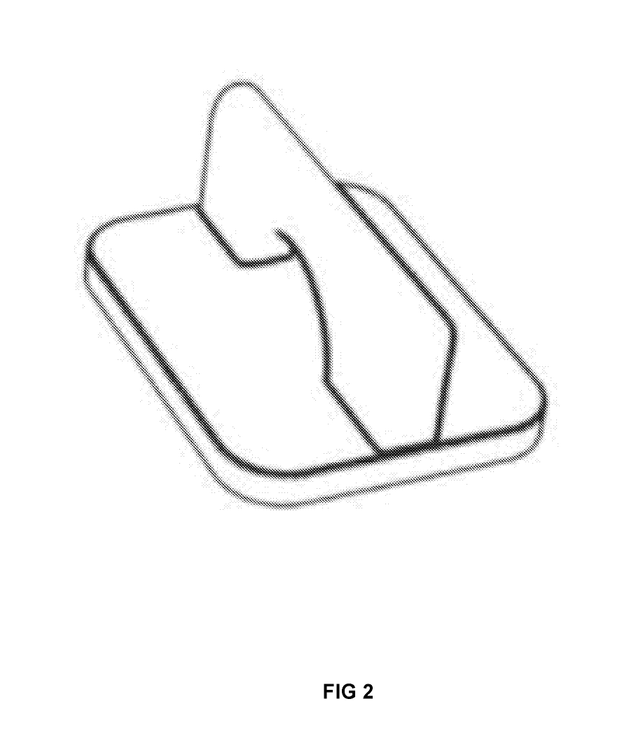

In that form of the present invention chosen for purposes of illustration, FIG. 2 shows a transfer board.

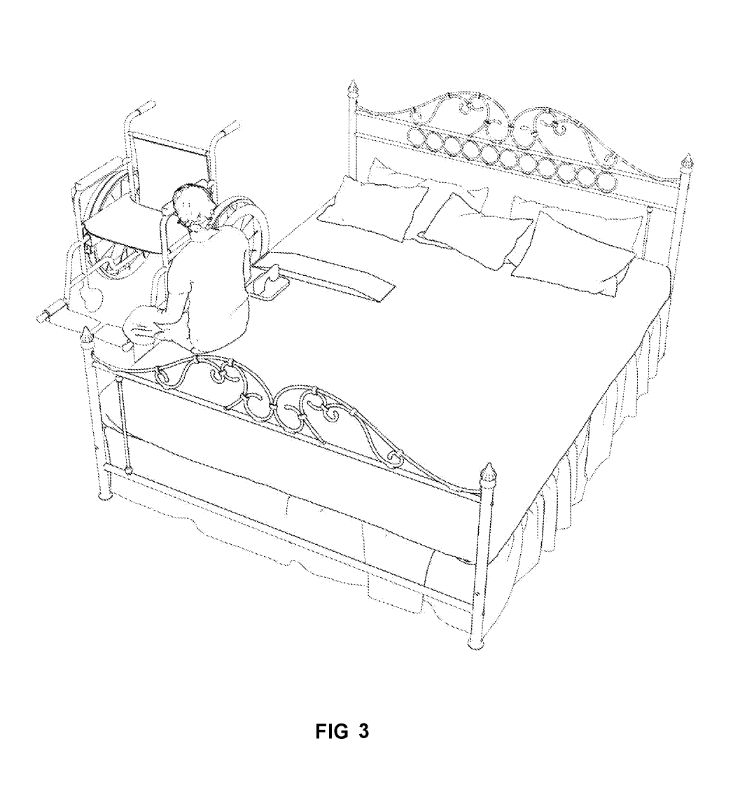

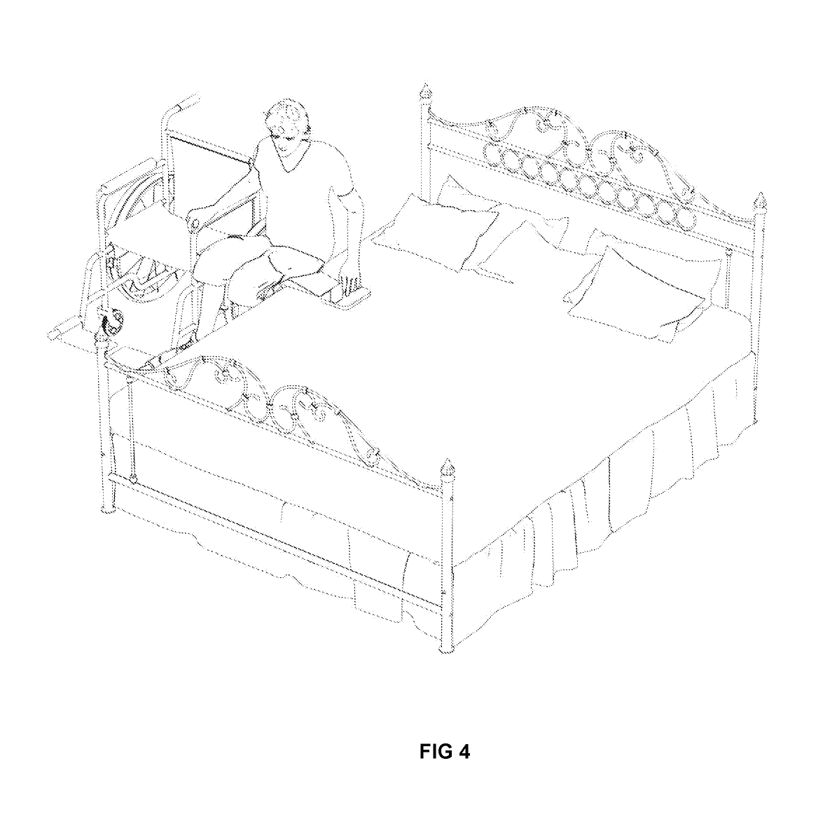

FIG. 3 and FIG. 4 depicts the use of the present invention by a wheelchair bound person to move from his bed to the wheelchair.

According to a preferred embodiment of the working of the present invention, there is shown in FIG. 3 a user seated on bed. Next to person is handheld support and transfer board. Proximate to bed is wheelchair. Handheld support and transfer board are within reach of user, and are used to effectively shift user's body weight between bed and wheelchair. First, user places board between bed and wheelchair to provide a surface for user to sit upon without having to stand upright.

According to a preferred embodiment of the working of the present invention, as shown in FIG. 4, user grasps handheld support with his or her hand, pressing it downward against board or bed. User thus has a sufficiently stable grab handle that is useful for transferring one's bodyweight across board between bed and wheelchair. As shown, the user is grasping the armrest of wheelchair. In many wheelchair designs, the armrest is removable to accommodate transfer boards. In such designs, user need only use one handheld support to transfer himself onto board while grasping the armrest. First, user can push against handheld support to inch closer and closer to wheelchair. Then, user can remove the armrest from wheelchair and place it on bed. User can then place handheld support downward against board closer from the edge of board making contact with bed, for example a few inches closer to the center of board, and then transfer handheld support to the other hand. Once in the other hand, the user can place handheld support downward against board on the wheelchair side of board, and shift bodyweight onto the right hand and slide onto wheelchair in a seated position. In wheelchair designs without armrests, two handheld supports can be used, one for each hand, to provide left and right grab handles for user.

According to a preferred embodiment of the working of the present invention, FIG. 4 shows an alternative perspective view of user on transfer board. Once again, user has two grab handles: one is the armrest of wheelchair and the other is handheld support placed on the edge of board and bed. User can push his bodyweight away from wheelchair with his right hand while maintaining a firm grasp on handheld support and shifting his bodyweight onto bed.

While the preferred embodiments of the present invention has been shown and described in detail, it is to be understood that numerous modifications can be made to the preferred embodiment without departing from the spirit of the invention. For example, a gripping surface may be placed on the bottom of handheld support, for example, rubber, plastic, fabric, or other material that increases the coefficient of static friction between handheld support and bed or wheelchair. Also, the shape and contour of handheld support can be changed to provide increased grip or less or more surface area to bring in contact with bed or wheelchair. As a person's physical abilities vary from user to user, handheld support can be adjusted accordingly to provide ease of use. In an alternative embodiment, the present invention includes a kit having at least one handheld support and transfer board.

Obviously, numerous variations and modifications can be made without departing from the spirit of the present invention. Therefore, it should be clearly understood that the forms of the present invention described above and shown in the figures of the accompanying drawings are illustrative only and are not intended to limit the scope of the present invention.

What is claimed is:

1. A medical mobility device comprising of:
a transfer board; and
a handheld support;
characterized in that said handheld support includes a gripping portion and a paddle portion attached to said gripping portion.

2. A medical mobility device as claimed in claim 1 wherein said gripping portion is dimensioned for a person's hand.

3. A medical mobility device as claimed in claim 1 wherein said paddle portion is attached to the gripping portion in a substantially perpendicular relationship with respect to the paddle portion.

4. A medical mobility device as claimed in claim 1 the transfer board is dimensioned to span a distance between a first seated position to a second seated position.

5. A medical mobility device as claimed in claim 1 and working thereof wherein a person's body is transferred from a first seated position to a second seated position by placing a transfer board between a first seated position and a second seated position

6. A medical mobility device as claimed in claim 1 and working thereof wherein the handheld support is placed at a first edge of the transfer board.

7. A medical mobility device as claimed in claim 1 and working thereof wherein the person pushes against the gripping portion of the handheld support in a substantially horizontal direction while shifting bodyweight away from the paddle portion

8. A medical mobility device as claimed in claim 1 and working thereof wherein the person's body is shifted in a seated position along the length of the transfer board from the first seated position to the second seated position.
